(19) United States
(12) Patent Application Publication
(10) Pub. No.: US 2026/0054384 A1
(43) Pub. Date: Feb. 26, 2026

(54) METHODS AND SYSTEMS FOR OPTIMIZING MULTI-ROBOT TASK ALLOCATION THROUGH HEURISTIC-GUIDED REINFORCEMENT

(71) Applicant: Tata Consultancy Services Limited, Mumbai (IN)

(72) Inventors: Aritra PAL, Kolkata (IN); Anandsingh CHAUHAN, Thane (IN); Mayank BARANWAL, Thane (IN)

(73) Assignee: Tata Consultancy Services Limited, Mumbai (IN)

(21) Appl. No.: 19/250,377

(22) Filed: Jun. 26, 2025

(30) Foreign Application Priority Data
Aug. 25, 2024 (IN) 202421064122

(51) Int. Cl. B25J 9/16

(52) U.S. Cl. CPC B25J 9/1661; B25J 9/161; B25J 9/163; B25J 9/1653

(57) ABSTRACT

The disclosure relates generally to methods and systems for optimizing multi-robot task allocation through heuristic-guided reinforcement learning in dynamic environments. Conventional RL framework-based approaches focus on optimal task selection, neglecting task-to-robot assignment under the assumption of constant robot availability post-selection. The present disclosure solves the technical problems in the art through heuristic-guided reinforcement learning (RL) in dynamic environments. The methods and systems of the present disclosure (coined as HeuRAL-MATE) combine heuristic guidance with RL to address the multi-robot task allocation challenge in warehouse environments. The HeuRAL-MATE effectively manages real-time task selection, the allocation of tasks to robots, and the secure navigation of robots, by minimizing both the total travel distance of robots and the delay in task execution while considering practical charging/discharging constraints and collision-free navigation of the robots.

### PRIORITY CLAIM

This U.S. patent application claims priority under 35 U.S.C. § 119 to: Indian Patent Application No. 202421064122, filed on Aug. 25, 2024. The entire contents of the aforementioned application are incorporated herein by reference.

### TECHNICAL FIELD

The disclosure herein generally relates to multi-robot task allocation (MRTA), and, more particularly, to methods and systems for optimizing multi-robot task allocation through heuristic-guided reinforcement learning in dynamic environments.

### BACKGROUND

Multi-robot systems in a cooperative environment find applications in several domains, including but not limited to search and rescue operations, precision agriculture, warehouse automation, construction, environmental monitoring, and transportation and logistics. Such multi-robot systems are characterized by availability of multiple robots collaborating to achieve common objectives, and offer numerous benefits, such as scalability, efficiency, and fault-tolerance.

Automating warehouse operations through utilization of the multi-robot systems engenders a unique spectrum of challenges rooted in the complexities of the spatial layout, the diverse range of tasks, the heterogeneity of robot capabilities, and the imperative for safe robotic navigation. From a broader perspective, these challenges can be categorized under three primary objectives: (a) Path planning, (b) Real-time robot assignment, and (c) Task allocation. While these objectives are interdependent, each gives rise to a distinct array of subproblems that necessitate resolution, subsequently influencing the comprehensive optimization of warehouse operations. For instance, the requisites of effective path planning encompass the generation of collision-free trajectories, encompassing both static obstacles and the trajectories of other in-motion robots. Moreover, the physical constraints of the robots, such as their state of charge (SOC), must also be factored in. In parallel, within the dynamic milieu of the warehouse, real-time task generation becomes imperative, precluding a priori knowledge. This injects complexities into the planning process, requiring the prioritization of tasks based on their generation time, anticipated completion timeframe while considering the concurrent execution of pre-assigned tasks, and the minimization of collective robot travel distances. Thus, the multi-robot task allocation (MRTA) has a combinatorial complexity in the warehouse environments that are dynamic in nature.

Furthermore, the immediate allocation of the robots to the tasks requires a seamless and continuous distribution of assignments, regardless of whether robots are available or already occupied. This requirement highlights the need for instant coordination across multiple goals, all while upholding a variety of distinct physical and task-related limitations. In essence, the intricate interplay of these challenges emphasizes the vital importance of a refined and flexible multi-robot framework. Such a framework must possess the capacity to systematically handle the nuances of path planning, real-time robot assignment, and task allocation within the dynamic landscape of an automated dynamic warehouse environment. Neglecting the interconnectedness of diverse subtasks leads to suboptimal outcomes.

Current MRTA research predominantly centers on two pivotal elements: (a) Model-driven optimization, and (b) Communication-efficient decentralized algorithms. The problem under consideration can be mapped to multi-agent pickup and delivery (MAPD) problems addressed using both the distributed approaches and centralized ones. But most existing literature focuses on offline MAPD which are not suitable for dynamic changing tasks in dynamic environments.

Driven by the recent achievements of deep RL in solving intricate dynamic challenges, a current trend is emerging to embrace learning-based approaches to manage the complexities of warehouses. These learning strategies target various facets of end-to-end warehouse management. For instance, a conventional Q-learning based framework emphasizes generating collision-free, secure paths for multi-robot systems. Conversely, the conventional RL framework-based approaches focus on optimal task selection, neglecting task-to-robot assignment under the assumption of constant robot availability post-selection. Additionally, some of the conventional techniques leverage A* (A Star) coupled with optimal reciprocal collision avoidance (ORCA) for collision-free navigation at the low-level path planning stage.

However, most of the conventional deep learning-based warehouse management approaches did not utilize the benefits of the reinforcement learning (RL) techniques. For instance, the learned policy of the conventional RL-agent is limited in its applicability to realistic warehouse scenarios due to the neglect of constraints related to robot availability and state of charge (SOC). Apart from that, they aim for a seamless sequential flow of tasks without considering their generation times. Likewise, some conventional techniques utilize a cooperative multi-agent RL framework under the assumption of robots never colliding which may not work in the real-time scenarios.

### SUMMARY

Embodiments of the present disclosure present technological improvements as solutions to one or more of the above-mentioned technical problems recognized by the inventors in conventional systems.

In an aspect, a processor-implemented method for optimizing multi-robot task allocation through heuristic-guided reinforcement learning in dynamic environments is provided. The method including the steps of: receiving a plurality of tasks to be performed by a plurality of robots in a dynamic environment, and wherein each task of the plurality of tasks comprises one or more task parameters and each robot of the plurality of robots are identified with one or more robot parameters, and wherein the one or more task parameters of each task comprises (i) a task origin, (ii) a task destination, (iii) a task length, (iv) a task appearing time in a task look-ahead (LA) buffer, and (v) a task generation time, and the one or more robot parameters of each robot comprises (i) a robot current position, (ii) a robot availability time, and (iii) a robot charging percentage; and allocating the plurality of tasks to the plurality of robots, through (i) a PPO based reinforcement learning model, and (ii) heuristics, based on the one or more task parameters of each task of the one or more tasks and the one or more robot parameters of each robot to obtain an optimized multi-robot task allocation, by: (a) initializing one or more policy network parameters and one or more value network parameters of the PPO based reinforcement learning model, wherein the PPO based reinforcement learning model comprises a plurality of feature extraction layers, a concatenation layer, and a policy layer; (b) moving one or more tasks out of the plurality of tasks that are unallocated, to the task look-ahead buffer, based on the task generation time of each task and a size of the task look-ahead buffer; (c) passing the one or more task parameters of each task of the one or more tasks to the plurality of feature extraction layers, to obtain a task-specific feature vector of each task of the one or more tasks; (d) passing the one or more robot parameters of each robot of the plurality of robots to the plurality of feature extraction layers, to obtain a robot-specific feature vector of each robot of the plurality of robots; (e) summation of (i) the task-specific feature vector of each task of the one or more tasks and (ii) the robot-specific feature vector of each robot of the plurality of robots, to obtain an integrated task-robot feature vector; (f) concatenating the integrated task-robot feature vector with an intermediate task-specific feature vector of each task of the one or more tasks using the concatenation layer, to obtain a concatenated task-robot feature vector, wherein the intermediate task-specific feature vector of each task is a part of the task-specific feature vector associated to each task; (g) passing the concatenated task-robot feature vector to the policy layer to allocate each task of the one or more tasks, at each time-step, to a robot of the plurality of robots, using the heuristics; (h) calculating a value of a reward function for training the PPO based reinforcement learning model, based on allocation of each task of the one or more tasks to the robot of the plurality of robots; (i) employing a navigation path algorithm for navigating the robot to complete each task allocated to each robot; (j) repeating the steps (c) through (i) until the one or more tasks present in the task look-ahead buffer is completed; (k) repeating the steps (b) through (j) until the plurality of tasks is completed; (l) calculating a value of a policy loss function and a value of a value loss function using the one or more policy network parameters and the one or more value network parameters, respectively; (m) updating the one or more policy network parameters and the one or more value network parameters of the PPO based reinforcement learning model, based on the value of the policy loss function and the value of the value loss function respectively to obtain one or more updated policy network parameters and one or more updated value network parameters; and (n) repeating the steps (a) through (m), until a plurality of episodes is completed by considering the one or more updated policy network parameters as the one or more updated policy network parameters and the one or more updated value network parameters as the one or more value network parameters.

In another aspect, a system for optimizing multi-robot task allocation through heuristic-guided reinforcement learning in dynamic environments is provided. The system includes: a memory storing instructions; one or more Input/Output (I/O) interfaces; and one or more hardware processors coupled to the memory via the one or more I/O interfaces, wherein the one or more hardware processors are configured by the instructions to: receive a plurality of tasks to be performed by a plurality of robots in a dynamic environment, and wherein each task of the plurality of tasks comprises one or more task parameters and each robot of the plurality of robots are identified with one or more robot parameters, and wherein the one or more task parameters of each task comprises (i) a task origin, (ii) a task destination, (iii) a task length, (iv) a task appearing time in a task look-ahead buffer, and (v) a task generation time, and the one or more robot parameters of each robot comprises (i) a robot current position, (ii) a robot availability time, and (iii) a robot charging percentage; and allocate the plurality of tasks to the plurality of robots, through (i) a PPO based reinforcement learning model, and (ii) heuristics, based on the one or more task parameters of each task of the one or more tasks and the one or more robot parameters of each robot to obtain an optimized multi-robot task allocation, by: (a) initializing one or more policy network parameters and one or more value network parameters of the PPO based reinforcement learning model, wherein the PPO based reinforcement learning model comprises a plurality of feature extraction layers, a concatenation layer, and a policy layer; (b) moving one or more tasks out of the plurality of tasks that are unallocated, to the task look-ahead buffer, based on the task generation time of each task and a size of the task look-ahead buffer; (c) passing the one or more task parameters of each task of the one or more tasks to the plurality of feature extraction layers, to obtain a task-specific feature vector of each task of the one or more tasks; (d) passing the one or more robot parameters of each robot of the plurality of robots to the plurality of feature extraction layers, to obtain a robot-specific feature vector of each robot of the plurality of robots; (e) summation of (i) the task-specific feature vector of each task of the one or more tasks and (ii) the robot-specific feature vector of each robot of the plurality of robots, to obtain an integrated task-robot feature vector; (f) concatenating the integrated task-robot feature vector with an intermediate task-specific feature vector of each task of the one or more tasks using the concatenation layer, to obtain a concatenated task-robot feature vector, wherein the intermediate task-specific feature vector of each task is a part of the task-specific feature vector associated to each task; (g) passing the concatenated task-robot feature vector to the policy layer to allocate each task of the one or more tasks, at each time-step, to a robot of the plurality of robots, using the heuristics; (h) calculating a value of a reward function for training the PPO based reinforcement learning model, based on allocation of each task of the one or more tasks to the robot of the plurality of robots; (i) employing a navigation path algorithm for navigating the robot to complete each task allocated to each robot; (j) repeating the steps (c) through (i) until the one or more tasks present in the task look-ahead buffer is completed; (k) repeating the steps (b) through (j) until the plurality of tasks is completed; (l) calculating a value of a policy loss function and a value of a value loss function using the one or more policy network parameters and the one or more value network parameters, respectively; (m) updating the one or more policy network parameters and the one or more value network parameters of the PPO based reinforcement learning model, based on the value of the policy loss function and the value of the value loss function respectively to obtain one or more updated policy network parameters and one or more updated value network parameters; and (n) repeating the steps (a) through (m), until a plurality of episodes is completed by considering the one or more updated policy network parameters as the one or more updated policy network parameters and the one or more updated value network parameters as the one or more value network parameters.

In yet another aspect, there are provided one or more non-transitory machine-readable information storage mediums comprising one or more instructions which when executed by one or more hardware processors cause: receiving a plurality of tasks to be performed by a plurality of robots in a dynamic environment, and wherein each task of the plurality of tasks comprises one or more task parameters and each robot of the plurality of robots are identified with one or more robot parameters, and wherein the one or more task parameters of each task comprises (i) a task origin, (ii) a task destination, (iii) a task length, (iv) a task appearing time in a task look-ahead buffer, and (v) a task generation time, and the one or more robot parameters of each robot comprises (i) a robot current position, (ii) a robot availability time, and (iii) a robot charging percentage; and allocating the plurality of tasks to the plurality of robots, through (i) a PPO based reinforcement learning model, and (ii) heuristics, based on the one or more task parameters of each task of the one or more tasks and the one or more robot parameters of each robot to obtain an optimized multi-robot task allocation, by: (a) initializing one or more policy network parameters and one or more value network parameters of the PPO based reinforcement learning model, wherein the PPO based reinforcement learning model comprises a plurality of feature extraction layers, a concatenation layer, and a policy layer; (b) moving one or more tasks out of the plurality of tasks that are unallocated, to the task look-ahead buffer, based on the task generation time of each task and a size of the task look-ahead buffer; (c) passing the one or more task parameters of each task of the one or more tasks to the plurality of feature extraction layers, to obtain a task-specific feature vector of each task of the one or more tasks; (d) passing the one or more robot parameters of each robot of the plurality of robots to the plurality of feature extraction layers, to obtain a robot-specific feature vector of each robot of the plurality of robots; (e) summation of (i) the task-specific feature vector of each task of the one or more tasks and (ii) the robot-specific feature vector of each robot of the plurality of robots, to obtain an integrated task-robot feature vector; (f) concatenating the integrated task-robot feature vector with an intermediate task-specific feature vector of each task of the one or more tasks using the concatenation layer, to obtain a concatenated task-robot feature vector, wherein the intermediate task-specific feature vector of each task is a part of the task-specific feature vector associated to each task; (g) passing the concatenated task-robot feature vector to the policy layer to allocate each task of the one or more tasks, at each time-step, to a robot of the plurality of robots, using the heuristics; (h) calculating a value of a reward function for training the PPO based reinforcement learning model, based on allocation of each task of the one or more tasks to the robot of the plurality of robots; (i) employing a navigation path algorithm for navigating the robot to complete each task allocated to each robot; (j) repeating the steps (c) through (i) until the one or more tasks present in the task look-ahead buffer is completed; (k) repeating the steps (b) through (j) until the plurality of tasks is completed; (l) calculating a value of a policy loss function and a value of a value loss function using the one or more policy network parameters and the one or more value network parameters, respectively; (m) updating the one or more policy network parameters and the one or more value network parameters of the PPO based reinforcement learning model, based on the value of the policy loss function and the value of the value loss function respectively to obtain one or more updated policy network parameters and one or more updated value network parameters; and (n) repeating the steps (a) through (m), until a plurality of episodes is completed by considering the one or more updated policy network parameters as the one or more updated policy network parameters and the one or more updated value network parameters as the one or more value network parameters.

In an embodiment, the heuristics employ one of: (i) a greedy best-first search algorithm, (ii) a minimum completion time (MCT) search algorithm, and (iii) a brute-force search algorithm, to select the robot out of the plurality of robots for assigning each task at time of the one or more tasks, based on the robot charging percentage.

In an embodiment, the reward function for training the PPO based reinforcement learning model is defined based on (i) a distance between the robot current position of each robot allocated to the task and the task origin associated to the task allocated with the robot, (ii) a difference between a time step at which the task is allocated with the robot and the task appearing time of the task in the task look-ahead buffer, and (iii) a penalty for each task of the one or more tasks present in the task look-ahead buffer being unallocated for more than a predefined threshold time.

In an embodiment, the navigation path algorithm determines a collision-free path planning for the robot allocated with each task to navigate through the robot current location, the task origin and the task destination, for completion of each task allocated to each robot.

In an embodiment, each task allocated and completed by the robot is removed from the task look-ahead buffer.

### BRIEF DESCRIPTION OF THE DRAWINGS

The accompanying drawings, which are incorporated in and constitute a part of this disclosure, illustrate exemplary embodiments and, together with the description, serve to explain the disclosed principles:

FIG. 1 is an exemplary block diagram of a system for optimizing multi-robot task allocation through heuristic-guided reinforcement learning in dynamic environments, in accordance with some embodiments of the present disclosure.

FIGS. 2A-2C illustrate exemplary flow diagrams of a processor-implemented method for optimizing multi-robot task allocation through heuristic-guided reinforcement learning in dynamic environments, using the system of FIG. 1, in accordance with some embodiments of the present disclosure.

FIG. 3 shows an exemplary dynamic warehouse environment of a typical sorting center, in accordance with some embodiments of the present disclosure.

FIG. 4 is an exemplary block diagram showing an architecture of the PPO based reinforcement learning model, in accordance with some embodiments of the present disclosure.

FIG. 5 is a graph illustrating an average training curve for the RL approach, in accordance with some embodiments of the present disclosure.

### DETAILED DESCRIPTION OF EMBODIMENTS

Exemplary embodiments are described with reference to the accompanying drawings. In the figures, the left-most digit(s) of a reference number identify the figure in which the reference number first appears. Wherever convenient, the same reference numbers are used throughout the drawings to refer to the same or like parts. While examples and features of disclosed principles are described herein, modifications, adaptations, and other implementations are possible without departing from the scope of the disclosed embodiments.

In modern warehousing environments, efficient multi-robot task allocation (MRTA) among multiple robots is crucial for optimizing productivity and meeting the ever-increasing demands of online order fulfillment. Efficient MRTA and path planning within unmanned warehouses lead to optimized order fulfillment, resource management, and obstacle-free navigation, ultimately elevating warehouse productivity. Consequently, the MRTA has garnered substantial interest, spanning from heuristic-driven approaches to contemporary learning-based methods in both centralized and distributed communication scenarios over the last two decades.

The present disclosure solves the technical problems in the art with methods and systems for optimizing multi-robot task allocation through heuristic-guided reinforcement learning (RL) in dynamic environments. The methods and systems of the present disclosure is coined as ‘HeuRAL-MATE’ which combines heuristic guidance with RL to address the multi-robot task allocation challenge in warehouse environments. The HeuRAL-MATE effectively manages real-time task selection, the allocation of tasks to robots, and the secure navigation of robots, all while considering constraints related to robot charging and specific task requirements. Notably, it boasts scalability, seamlessly accommodating any quantity of robots and task frequencies.

The methods and systems of the present disclosure address the challenging problem of real-time multi-robot task allocation (MRTA) in the dynamic environments, where tasks appear dynamically with corresponding start and end locations. The objective of the present disclosure is to minimize both the total travel distance of robots and the delay in task execution while considering practical charging/discharging constraints and collision-free navigation of the robots.

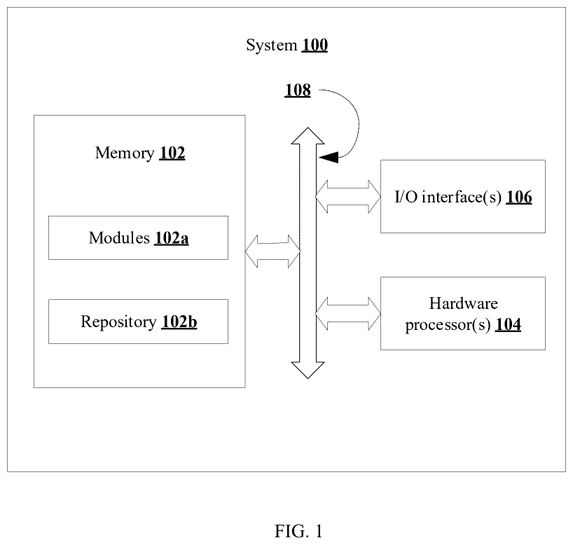

Referring now to the drawings, and more particularly to FIG. 1 through FIG. 5, where similar reference characters denote corresponding features consistently throughout the figures, there are shown preferred embodiments, and these embodiments are described in the context of the following exemplary system and/or method.

FIG. 1 is an exemplary block diagram of a system 100 for optimizing multi-robot task allocation through heuristic-guided reinforcement learning in dynamic environments, in accordance with some embodiments of the present disclosure. In an embodiment, the system 100 includes or is otherwise in communication with one or more hardware processors 104, communication interface device(s) or input/output (I/O) interface(s) 106, and one or more data storage devices or memory 102 operatively coupled to the one or more hardware processors 104. The one or more hardware processors 104, the memory 102, and the I/O interface(s) 106 may be coupled to a system bus 108 or a similar mechanism.

The I/O interface(s) 106 may include a variety of software and hardware interfaces, for example, a web interface, a graphical user interface (GUI), and the like. The I/O interface(s) 106 may include a variety of software and hardware interfaces, for example, interfaces for peripheral device(s), such as a keyboard, a mouse, an external memory, a plurality of sensor devices, a printer and the like. Further, the I/O interface(s) 106 may enable the system 100 to communicate with other devices, such as web servers and external databases.

The I/O interface(s) 106 can facilitate multiple communications within a wide variety of networks and protocol types, including wired networks, for example, local area network (LAN), cable, etc., and wireless networks, such as Wireless LAN (WLAN), cellular, or satellite. For the purpose, the I/O interface(s) 106 may include one or more ports for connecting a number of computing systems with one another or to another server computer. Further, the I/O interface(s) 106 may include one or more ports for connecting a number of devices to one another or to another server.

The one or more hardware processors 104 may be implemented as one or more microprocessors, microcomputers, microcontrollers, digital signal processors, central processing units, state machines, logic circuitries, and/or any devices that manipulate signals based on operational instructions. Among other capabilities, the one or more hardware processors 104 are configured to fetch and execute computer-readable instructions stored in the memory 102. In the context of the present disclosure, the expressions ‘processors’ and ‘hardware processors’ may be used interchangeably. In an embodiment, the system 100 can be implemented in a variety of computing systems, such as laptop computers, portable computers, notebooks, hand-held devices, workstations, mainframe computers, servers, a network cloud and the like.

The memory 102 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. In an embodiment, the memory 102 includes a plurality of modules 102a and a repository 102b for storing data processed, received, and generated by one or more of the plurality of modules 102a. The plurality of modules 102a may include routines, programs, objects, components, data structures, and so on, which perform particular tasks or implement particular abstract data types.

The plurality of modules 102a may include programs or computer-readable instructions or coded instructions that supplement applications or functions performed by the system 100. The plurality of modules 102a may also be used as, signal processor(s), state machine(s), logic circuitries, and/or any other device or component that manipulates signals based on operational instructions. Further, the plurality of modules 102a can be used by hardware, by computer-readable instructions executed by the one or more hardware processors 104, or by a combination thereof. In an embodiment, the plurality of modules 102a can include various sub-modules (not shown in FIG. 1). Further, the memory 102 may include information pertaining to input(s)/output(s) of each step performed by the processor(s) 104 of the system 100 and methods of the present disclosure.

The repository 102b may include a database or a data engine. Further, the repository 102b amongst other things, may serve as a database or includes a plurality of databases for storing the data that is processed, received, or generated as a result of the execution of the plurality of modules 102a. Although the repository 102b is shown internal to the system 100, it will be noted that, in alternate embodiments, the repository 102b can also be implemented external to the system 100, where the repository 102b may be stored within an external database (not shown in FIG. 1) communicatively coupled to the system 100. The data contained within such external database may be periodically updated. For example, data may be added into the external database and/or existing data may be modified and/or non-useful data may be deleted from the external database. In one example, the data may be stored in an external system, such as a Lightweight Directory Access Protocol (LDAP) directory and a Relational Database Management System (RDBMS). In another embodiment, the data stored in the repository 102b may be distributed between the system 100 and the external database.

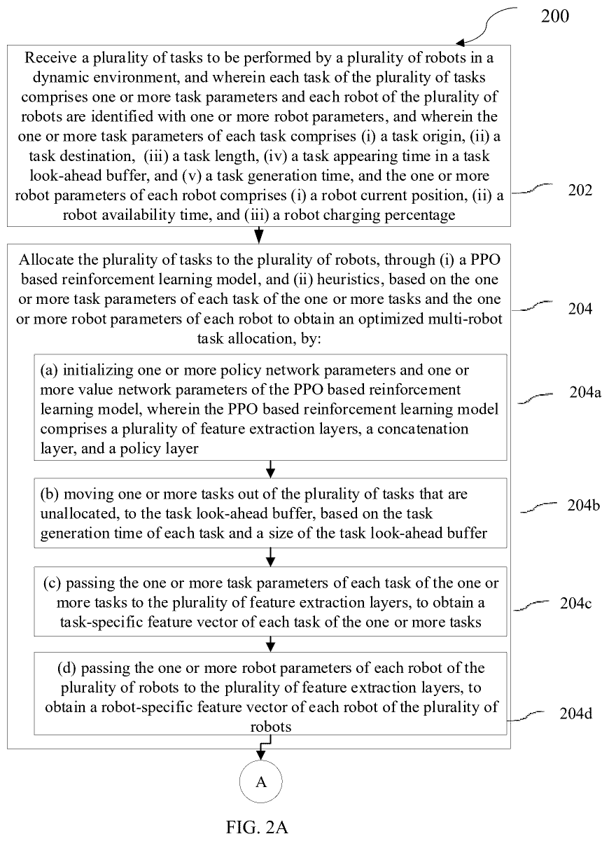

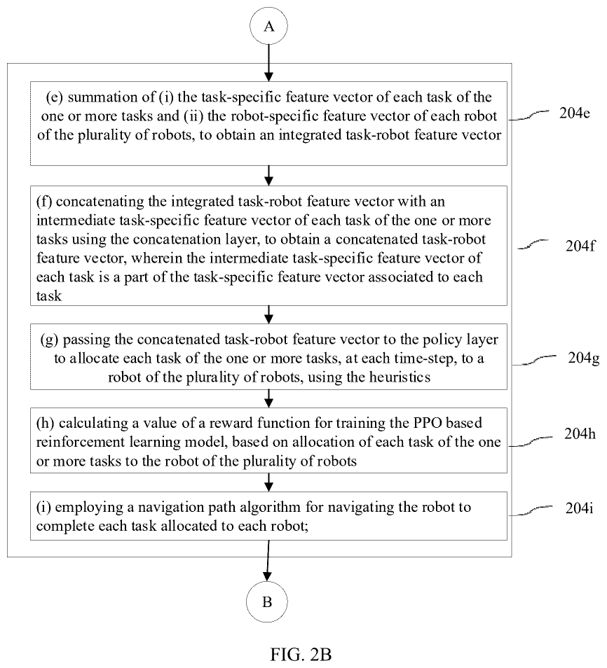

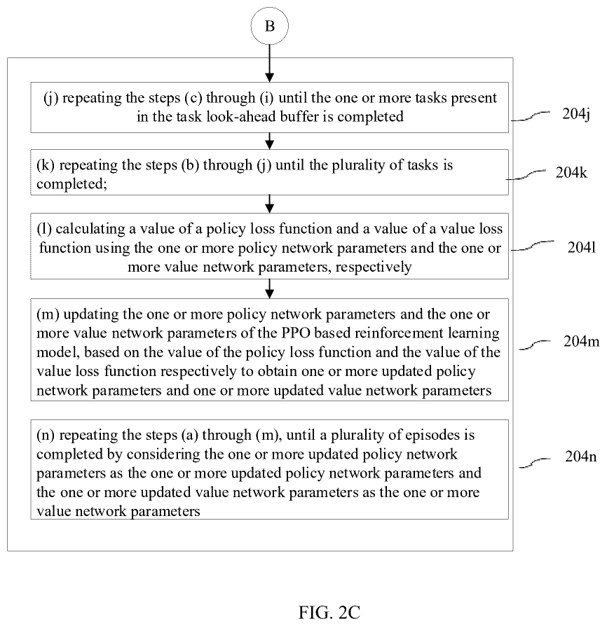

Referring to FIGS. 2A-2C, components and functionalities of the system 100 are described in accordance with an example embodiment of the present disclosure. For example, FIGS. 2A-2C illustrate exemplary flow diagrams of a processor-implemented method 200 for optimizing multi-robot task allocation through heuristic-guided reinforcement learning in dynamic environments, using the system of FIG. 1, in accordance with some embodiments of the present disclosure. Although the steps of the method 200 shown in FIGS. 2A-2C including process steps, method steps, techniques or the like may be described in a sequential order, such processes, methods, and techniques may be configured to work in alternate orders. In other words, any sequence or order of steps that may be described does not necessarily indicate a requirement that the steps be performed in that order. The steps of processes described herein may be performed in any practical order. Further, some steps may be performed simultaneously, or some steps may be performed alone or independently.

At step 202 of the method 200, the one or more hardware processors 104 of the system 100 are configured to receive via the one or more I/O interfaces 106, a plurality of tasks to be performed by a plurality of robots in the given dynamic environment. Each task of the plurality of tasks includes one or more task parameters. Similarly, each robot of the plurality of robots is identified with one or more robot parameters. The one or more task parameters of each task includes (i) a task origin, (ii) a task destination, (iii) a task length, (iv) a task appearing time in a task look-ahead buffer, and (v) a task generation time.

In an embodiment, the task origin is a starting point of each task from which the task is to be initiated. The task destination is the ending point of the corresponding task at which the task is completed/terminated. The task length is defined as the distance of the collision-free path between the task origin and the task destination of each task. The task appearing time defines the time at which the task is moved to the look-ahead buffer. The look-ahead buffer has a predefined size based on which the number of tasks out of the plurality of tasks are moved for the execution. In an embodiment, a single task may be moved to the look-ahead buffer at a time. In another embodiment, 2 or more than 2 tasks (but less than the predefined size) may be moved at a time to the look-ahead buffer. The task generation time is the time at which the task is generated. The generated tasks are pooled to the plurality of tasks before they appear in the look-ahead buffer for the execution.

The one or more robot parameters of each robot includes (i) a robot current position, (ii) a robot availability time, and (iii) a robot charging percentage. In an embodiment, the robot current position is the current location at which the corresponding robot is present at the given time. The robot current position change time to time based on the navigation. The robot availability time defines the time at which the robot may be available to execute the task. In an embodiment, the robot availability time may be immediate (is zero) when the corresponding robot is free and immediately available. In another embodiment, the robot availability time may vary when the corresponding robot is busy with the execution of another task and is not immediately available. The robot charging percentage defines the remaining charging percentage left of the corresponding robot.

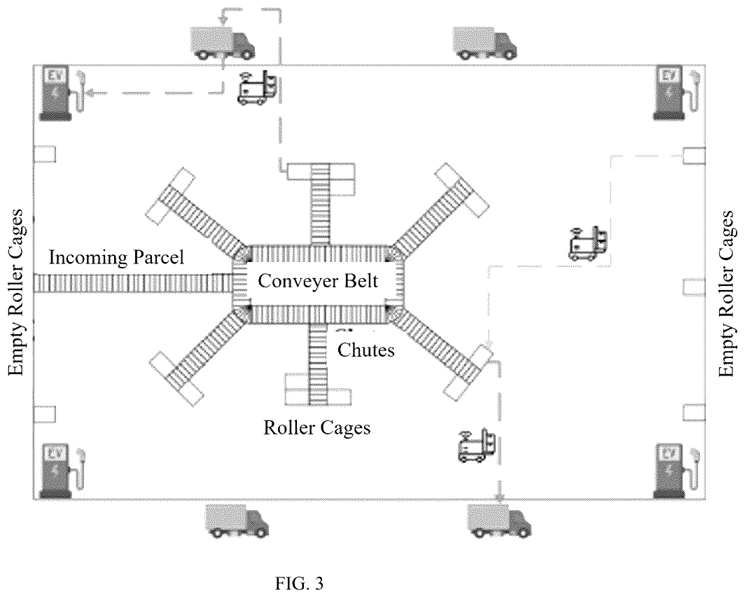

FIG. 3 shows an exemplary dynamic warehouse environment of a typical sorting center, in accordance with some embodiments of the present disclosure. As shown in FIG. 3, the tasks are parcel pickup from each bin of the conveyor belt and drop it to the appropriate designated pickup trucks situated across the warehouse by the deployed robots. The goal is to optimize end-to-end operations within a typical sorting center. Incoming packages must be efficiently directed from conveyor belts to designated pickup trucks situated across the warehouse. These packages are stored in bins at conveyor ends, and as bins approach full capacity, the robots are tasked with emptying them near assigned pickup points. Additionally, robots are assigned to move the empty bins closer to the conveyor belts. Amidst these tasks, the robots must navigate without collisions, maintain adequate energy levels, and dock for recharging if needed. Real-time package arrivals render offline optimization of robot assignments and task selection challenging when confronted with multiple pending tasks. Furthermore, addressing charging constraints is often disregarded in existing warehouse management literature. In real-time decision-making, the brute-force or simulation-based approaches evaluating all assignment scenarios prove impractical and inefficient for such systems.

At step 204 of the method 200, the one or more hardware processors 104 of the system 100 are configured to allocate the plurality of tasks to the plurality of robots, through (i) a PPO based reinforcement learning (RL) model, and (ii) heuristics. The allocation is done based on the one or more task parameters of each task of the one or more tasks and the one or more robot parameters of each robot received at step 202 of the method 200. Once the plurality of tasks is allocated to all the robots, an optimized multi-robot task allocation is obtained.

The complex interplay among diverse subtasks, combined with the real-time influx of tasks and the varying state of charge (SOC) of robots, accentuates the limitations of existing warehouse management strategies. The typical warehouse environment is characterized by its dynamic nature, necessitating a real-time, sequential decision-making approach for effective optimization. In the present context, RL emerges as the optimal choice, given its ability for handling such scenarios. Furthermore, the RL can adeptly learn to optimize its task selection procedure in conjunction with other heuristic policies, alongside a searching approach for robot selection and charging. Hence, the optimization of task selection occurs in tandem with existing operational policies, rather than in isolation.

The problem of the MRTA in dynamic warehouse environment settings can be modeled as a Markov Decision Process (MDP). An MDP is denoted by the tuple (S,A,P_{A},r), where S and A represent the finite set of states and actions, respectively. For each s,s′∈P_{A}, the transition probability from s→s′ under the effect of an action a∈A, is denoted by pₐ(s,s′)∈P_{A}. Finally, the step-reward associated with each state-action pair (s,a) is depicted by r(s,a). In an embodiment, the states, actions and reward are explained below in the context of warehouse management.

States: At each time step, the comprehensive state of the dynamic warehouse environment necessitates the inclusion of information pertaining to tasks and robots. Incoming tasks are immediately stored in a buffer, creating a limited-size look-ahead (LA) buffer (queue) in a first-in-first-out (FIFO) fashion. The RL agent is trained to optimally select tasks from this queue based on the current environment state. Designated as sₜ∈S at time-step t, the environment's state encompasses task attributes including their source and destination coordinates, navigation duration between them obtained via the searching algorithm, and the time of task appearance in the environment's LA. Furthermore, robot features entail their positions, the time at which an engaged robot becomes free for executing subsequent tasks, and their charge levels.

Actions: The planner's main objective is to enhance task assignment, thereby minimizing total operational time. Accordingly, the planner's actions encompass systematic task selection from the queue. This sequential selection reduces both the overall operational expenses and the task completion time.

Rewards: The step reward attributed to a task-action pair encompasses three distinct components. The initial component is calculated based on the time it takes for the robot to travel from its current position to the task's starting point, termed as travel time to origin (TRTO). The second facet is the time gap between task arrival in the LA and the robot's initiation of execution, denoted as the total time gap for the task (TTGT). Additionally, the step reward incorporates a third element that enforces penalties for tasks lingering in the queue for extended periods. This reflects the real-world principle that tasks ideally should not remain unattended for prolonged duration.

Allocating the plurality of tasks to the plurality of robots, through (i) heuristics, and (ii) the PPO based reinforcement learning model is explained through steps 204a to 204n. At step 204a, one or more policy network parameters and one or more value network parameters of the PPO based reinforcement learning model are initiated. In an embodiment, a copy of the PPO based reinforcement learning model is acted as a policy network containing the one or more policy network parameters and another copy of the PPO based reinforcement learning model is acted as a value network containing the and one or more value network parameters. Both the policy network and the value network resemble a typical actor-critic model. The values of the one or more policy network parameters and one or more value network parameters are typically referred to network weights or simply the weights of the corresponding network.

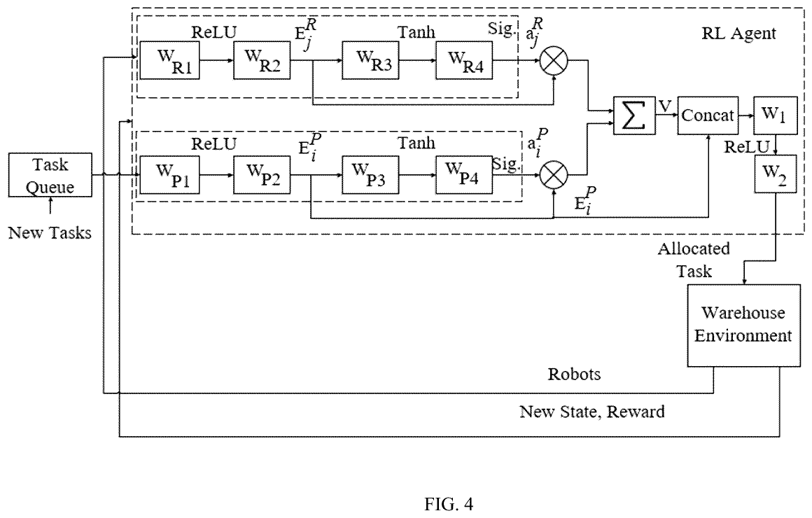

FIG. 4 is an exemplary block diagram showing an architecture of the PPO based reinforcement learning model, in accordance with some embodiments of the present disclosure. In an embodiment, the PPO based reinforcement learning model includes a plurality of feature extraction layers, a concatenation layer, and a policy layer.

At step 204b, the one or more tasks out of the plurality of tasks that are unallocated, are moved to the task LA buffer, based on the task generation time of each task and the size of the task. For example, if the number of the plurality of tasks are 1000 and the size of the task LA buffer is 10, then 10 tasks that are generated first are moved one at a time in the same order of generation to the task LA buffer. The one or more tasks that are present in the task LA buffer are executed first one at a time based on the allocation, and once the one or more tasks in the first batch are allocated and executed, the second batch of the one or more tasks that are unallocated are moved to the task LA buffer, and so on until the plurality of tasks are allocated with the robots and are executed.

The generation of tasks occurs in real-time, initially populating a task buffer. The planner (RL agent) has access to a small LA buffer of tasks. When a task from the LA, visible to the RL agent, is assigned to a robot for execution, a new task from the buffer enters the LA, making it available for selection by the RL agent. Upon task allocation from the LA buffer, if no new tasks are available in the buffer for inclusion in the LA, the task with the longest duration of stay in the LA is duplicated to ensure a consistent LA length. This increases the probability of its selection by the RL agent in subsequent steps. In an exceptional scenario where both the LA and the task buffer are empty, the system 100 of the present disclosure waits for a task to appear in the environment. This process of action selection revolves around task choice, unfolds across three hierarchical levels: (a) At each instant t, the RL agent picks a task from the LA for assignment to one of the robots, guided by the prevailing environmental state. Importantly, the RL agent doesn't wait for robots to become available before engaging in task selection, as the state information includes time markers denoting when robots will be free, (b) upon the task selection, the heuristic-guided framework is employed to facilitate the identification of the most suitable robot for task execution, and (c) to direct the robot's movement.

At step 204c, the one or more task parameters of each task of the one or more tasks that are moved to the task LA buffer at step 204b are passed to the plurality of feature extraction layers, to obtain a task-specific feature vector of each task of the one or more tasks. More specifically, the task-specific feature vector of each task includes the corresponding one or more task parameters in the form of embeddings.

At step 204d, the one or more robot parameters of each robot of the plurality of robots are passed to the plurality of feature extraction layers, to obtain a robot-specific feature vector of each robot of the plurality of robots. More specifically, the robot-specific feature vector of each robot includes the corresponding one or more robot parameters in the form of the embeddings.

At step 204e, the task-specific feature vector of each task of the one or more tasks obtained at step 204c and the robot-specific feature vector of each robot of the plurality of robots obtained at step 204d are added to obtain an integrated task-robot feature vector. More specifically, the integrated task-robot feature vector includes the task-specific feature vector of each task and the robot-specific feature vector of each robot in the form of embeddings.

At step 204f, the integrated task-robot feature vector obtained at step 204e is concatenated with an intermediate task-specific feature vector of each task of the one or more tasks using the concatenation layer, to obtain a concatenated task-robot feature vector. The intermediate task-specific feature vector of each task is a part of the task-specific feature vector associated to each task.

At step 204g, the concatenated task-robot feature vector obtained at step 204f is passed to the policy layer to allocate each task of the one or more tasks, at each time-step, to a robot of the plurality of robots, using the heuristics. In an embodiment, the heuristics employ one of: (i) a greedy best-first search algorithm, (ii) a minimum completion time (MCT) search algorithm, and (iii) a brute-force search algorithm, to select the robot out of the plurality of robots for assigning each task at time of the one or more tasks, based on the robot charging percentage.

At step 204h, a value of a reward function is calculated for training the PPO based reinforcement learning model, based on allocation of each task of the one or more tasks to the robot of the plurality of robots at step 204g.

To learn to perform optimal sequential decision making, an on-policy PPO agent of the PPO based reinforcement learning model is trained with a prioritized replay buffer defined over the set of environment states. The state of the agent consists of the features related to tasks in the LA (denoted by P) as well as set of robots (R). The agent's state, denoted as sₜ∈S at time-step t, encompasses the following components: (a) the task origin coordinates {oᵢ}, (b) the task destination coordinates {dᵢ}, (c) the task length (distance information between task origin and destination) {kᵢ}, (d) timestamp or the task appearing time in a task LA buffer {lᵢ}, (e) the robot current position coordinates {pⱼ}, (f) the robot availability time and the anticipated time for ongoing task completion {rⱼ}, (g) the robot charge percentage {cⱼ}. The features (a)-(d) are task-specific features and collectively have a dimensionality of 6 for each task. Conversely, features (e)-(g) are linked to robot-specific attributes, constituting a dimensionality of 3 for setups without charging considerations and 4 for the ones with charging constraints.

In an embodiment, the reward function for training the PPO based reinforcement learning model is defined based on (i) a distance between the robot current position of each robot allocated to the task and the task origin associated to the task allocated with the robot, (ii) a difference between a time step at which the task is allocated with the robot and the task appearing time of the task in the task LA buffer, and (iii) a penalty for each task of the one or more tasks present in the task LA buffer being unallocated for more than a predefined threshold time.

Consider (x₀_{ᵢ},y₀_{ᵢ}) and (x_{d}_{ᵢ},y_{d}_{ᵢ}) represent the origin and destination coordinates of the ith-indexed task. Similarly, (xᵣ_{ⱼ},yᵣ_{ⱼ}) indicates the current position of robot j, which can vary based on whether the robot is idle, performing tasks, or at a charging location for recharging if needed. Further, t_{stamp,i}, t_{exec}_{ᵢ}, and t_{wait}_{ᵢ} denote the time when task i appears in the task allocation (referred to as LA), the time at which its execution begins, and the waiting time for a robot to start executing the task after completing other preassigned tasks, respectively. In each decision-making step, the variable allotT is used to signify the index of the selected task which then gets assigned to a robot selR. Furthermore, we the function d[(xₐ,yₐ), (x_{b},y_{b})] is used to calculate the A* distance between two points (xₐ,yₐ) and (x_{b},y_{b}). The step reward for training the PPO agent is:

$${R}_{step} = - d [ ( {x}_{{r}_{seIR}} , {y}_{{r}_{seIR}} ) , ( {x}_{{o}_{allotT}} , {y}_{{o}_{allotT}} ) ] - α * ( {t}_{{exec}_{allotT}} - {t}_{{stamp}_{allotT}} ) - β * Penalty \qquad ( 2 )$$

### Where,

$$Penalty = \{ \begin{matrix}p , if {t}_{{wait}_{allotT}} > {t}_{threshold} \\ 0 , otherwise\end{matrix}$$

The Penalty function imposes a penalty of p in cases where a task indexed as allotT remains in the LA for a duration exceeding a specified threshold t_{threshold}. The coefficients α and β represent positive constants. The first term in equation (1) corresponds to the TRTO, while the second term is associated with TTGT.

Upon the task selection, the heuristic-guided framework comes into play, facilitating the identification of the most suitable robot for task execution. This determination considers the positions of all the robots post completion of their ongoing assignments, the times they become available, and their SOCs.

In an embodiment, a simple heuristic based approach is considered where the execution time for all the existing robots is calculated. The robot selected for a particular task is the one capable of completing the task earliest. There is a possibility that a robot, even if immediately available but located farther away, might not be able to promptly finish the task. Hence, a comprehensive heuristic is employed to ascertain the most suitable robot for task execution.

According to the present disclosure, both (a) non-charging and (b) charging scenarios are tackled in the dynamic warehouse settings. In the charging scenario, the unique behavior of robots that do not discharge are accounted while stationary but discharge at a steady rate during motion. When a robot's charge falls below a predefined threshold (charging threshold), the corresponding robot navigates to the nearest available charging dock for recharging. The threshold is calibrated to ensure that it enables the robot to reach the nearest charging dock from any location on the grid. During task assignment, the robot's current battery percentage level is compared with the anticipated charge required to complete the task against this threshold. This guarantees that the robot will always fulfill its assigned tasks without facing any issues related to insufficient battery levels. In the simplified non-charging scenario, the robots consistently maintain charge levels above the charging threshold.

At step 204i, the robot that is allocated with the task is employed with a navigation path algorithm for navigating the corresponding robot to complete each task allocated to each robot. In an embodiment, the navigation path algorithm determines a collision-free path planning for the robot allocated with each task to navigate through the robot current location, the task origin and the task destination, for completion of each task allocated to each robot.

In an embodiment, the navigation path algorithm is one of a navigation search algorithms in the list including but is not limited to: (i) a Space-Time A* or a Cooperative A* (CA*) algorithm that extends the A* algorithm to handle spatiotemporal planning by integrating time and space constraints into the search process, (ii) a Hierarchical Cooperative A* (HCA*) algorithm which uses a hierarchical approach to A* algorithm that simplifies complex problems by breaking them into manageable subproblems and coordinating solutions across these levels, and (iii) a Windowed Hierarchical Cooperative A* (WHCA*) algorithm which limits the Space-Time search depth to a dynamic window, spreading computation over the duration of the route.

In an embodiment, the Space-Time A* preferred over the others to direct the robot's movement, as it directly incorporates temporal constraints into the planning process, making it well-suited for dynamic environments where both spatial and temporal factors are crucial. The Space-Time A* algorithm is utilized to guide the robot from its current position to the task's starting point and subsequently to the destination, ensuring collision avoidance with both stationary and moving obstacles (and other robots).

At step 204j, the steps (204c) through (204i) are repeated until the allocation of the one or more tasks (allocated in the first batch) present in the task LA buffer is completed. Each task that is allocated and completed by the robot is removed from the task LA buffer.

At step 204k, the steps (204b) through (204j) are repeated until the allocation of the plurality of tasks received at step 202 of the method 200 is completed. After the successful completion of the step 204k, the training process is marked as an episode is completed. More specifically, the steps through 204a to 204m are referred to as one episode in the training process of the of the PPO based reinforcement learning model.

At step 204l, a value of a policy loss function and a value of a value loss function are calculated using the one or more policy network parameters and the one or more value network parameters, respectively. More specifically, the value of a policy loss function is calculated based on the values (weights) of one or more policy network parameters. Similarly, the value of the value loss function is calculated based on the (weights) of one or more value network parameters.

At step 204m, the one or more policy network parameters and the one or more value network parameters of the PPO based reinforcement learning model, are updated based on the value of the policy loss function and the value of the value loss function respectively to obtain one or more updated policy network parameters and one or more updated value network parameters.

Finally, at step 204n, the steps (204a) through (204m) are repeated until a plurality of episodes is completed by considering the one or more updated policy network parameters as the one or more updated policy network parameters and the one or more updated value network parameters as the one or more value network parameters, to obtain the optimized multi-robot task allocation.

The optimized multi-robot task allocation obtained at step 204 is then deployed in real-time in the given dynamic environment to execute the tasks by the deployed robots.

The methods and systems of the present disclosure integrate task arrival times to ensure the timely execution of tasks by amalgamating practical considerations, such as robot availability, SOC and generating collision-free paths, performance under distribution shifts and variable-sized fleet. In the present disclosure, the reward structure is meticulously crafted to achieve an optimal balance between prompt task allocation and the shortest possible execution duration for the allocated tasks. This is achieved by harmonizing efficient heuristics with the RL agent. The approach of the present disclosure also ensures competitive runtime during the deployment phase, catering to real-time task selection and allocation.

The methods and systems of the present disclosure feature the real-time warehouse management under practical constraints. Contemporary warehouse management research frequently relies on impractical assumptions, like assuming robots never collide, are always instantly available for tasks, or never discharge. The methods and systems of the present disclosure present a holistic framework that eliminates these assumptions. Task selection is optimized to improve decision-making throughout all process stages, employing efficient heuristics to address practical constraints. The task selection process is performed, based on RL, to act optimally in tandem with these heuristics, facilitating cooperative learning under realistic warehouse conditions.

The framework ‘HeuRAL-MATE’ of the present disclosure thus ensures that the task selection carried out by the RL agent is suitably influenced by the performances of concurrently employed heuristic policies. The methods and systems of the present disclosure achieve the online task allocation for reliable solutions in dynamic environments where solving optimization problems every time can be computationally prohibitive.

### Example Scenario:

Datasets and Experimental Setup: The dynamic warehouse environment in the experimental setup includes several critical parameters that govern its efficient operation. To evaluate the performance of the present disclosure, synthetic data was used due to the absence of publicly accessible real-world datasets for comparable problem instances. Each episode encompasses some τ time units, and the synthetic datasets employed for training and evaluation are structured as square-shaped 2-dimensional (2-D) grids within the range of [0, 64]×[0, 64]. The task origin and destination, as well as robot locations, are within the above range. In the experiments, the concentration of tasks is varied to capture specific time intervals during the day when majority of the tasks tend to accumulate. Accordingly, the datasets were generated using Gaussian distributions with varying means and standard deviations. The task's starting and ending coordinates, along with task generation times, were disclosed to the planner using a limited-size LA. The dataset also includes initial charge levels and locations of charging docks. In the experiments, below four unique combinations are investigated:
1. Non-charging+Normally distributed task arrival times
2. Charging+Normally distributed task arrival times
3. Non-charging+Uniformally distributed task arrival times
4. Charging+Uniformally distributed task arrival times

Within each of the four configurations, datasets containing approximately 500 tasks per episode are generated following the corresponding distributions. As an illustration, in the case of normally distributed tasks, task generation times adhere to N (600,50), with 600 denoting the mean task generation time. A fleet of 10 robots was considered first, and the LA length was fixed at 5. The robots' permissible charging threshold is established at 30%, signifying that robots with a SOC below 30% must dock for recharging before resuming task execution. The steady charging rate for the robots is calibrated to be 16 times the discharging rate.

Neural Network Architecture and Training: The RL agent employs the PPO based reinforcement learning model framework of the present disclosure to facilitate online task selection. The model architecture was distinctly structured into three core segments:

Feature Extraction Layers: This initial component involves the procedure of feature extraction, particularly focusing on attributes related to robots and tasks. The embedding for robot attributes is created using a sequence of four linear layers of dimensions [Input, 16, 16, 1]. Here, the Input is 3 for scenarios excluding charging considerations, and 4 for scenarios involving charging constraints. Concurrently, embeddings related to task attributes are generated using a similar sequence of four linear layers of dimensions [6, 16, 16, 1].

Consider

$${F}_{j}^{R} and {F}_{i}^{P}$$

represent the feature vectors for the robot j∈R and the ith-task, then the associated embeddings are defined as:

$${E}_{j}^{R} = {W}_{R 2} * R e L U ( {W}_{R 1} * {F}_{j}^{R} )$$

$${E}_{i}^{P} = {W}_{P 2} * R e L U ( {W}_{P 1} * {F}_{i}^{P} )$$

Concatenation layer: The concatenation layer transforms the extracted embeddings by concatenating the embeddings of robots and tasks. Subsequently, the concatenated feature is channeled through a linear layer boasting 48 input neurons and 8 output neurons with ReLU activation. Mathematically represented as:

$${a}_{j}^{R} = Sigmoid ( {W}_{R 4} * Tanh ( {W}_{R 3} * {E}_{j}^{R} ) )$$

$${a}_{i}^{P} = Sigmoid ( {W}_{P 4} * Tanh ( {W}_{P 3} * {E}_{i}^{P} ) )$$

$$Output = ( \sum {E}_{j}^{R} * {a}_{j}^{R} , \sum {E}_{i}^{P} * {a}_{i}^{P} , {E}_{i}^{P} )$$

Final Layer: The final layer is the policy layer comprising a linear layer, this element operates with 8 input neurons and 1 output neuron.

$${Task}^{A l l o c a t e d} = Categorial ( {W}_{2} * R e L U ( {W}_{1} * Output ) )$$

The PPO based reinforcement learning model framework of the present disclosure was implemented using the PyTorch library in Python 3.8, with an Adam optimizer, a discount factor at 0.99, lambda value of 0.95, learning rate of 0.0003, entropy coefficient of 0.001, value function coefficient of 0.0002, and a batch size of 32. The policy network is trained employing the cross-entropy loss function, whereas the value network is fine-tuned via an MSE loss metric.

Baselines: It is crucial to re-emphasize that there is no existing work in the literature that concurrently addresses multiple aspects of MRTA. In the absence of any known approaches, the two strong baselines mentioned below are considered:
1. Brute-force optimal: where all task-robot pairs (within the LA) undergo a brute-force evaluation of time duration required for task execution by the robots, determined using the standard A* navigation algorithm. Subsequently, the algorithm selects the robot-action pair that minimizes this time duration. Consequently, while brute-force optimal approach represents a locally optimal solution, the brute-force evaluation significantly amplifies the run-time, posing practical challenges. The brute-force optimal baseline is frequently adopted in literature as a reference point for evaluating decoupled task allocation and navigation methodologies.
2. FIFO: The FIFO baseline employs a dual-tiered decision framework. Initial allocation entails selecting the task that joined the LA buffer earliest. The goal is to reduce pending tasks within the LA buffer and minimize the time gap between task arrival and robot initiated execution (TTGT). Due to its simplicity, the FIFO approach requires the least execution time among all the considered approaches.

Experiments and Results: a comprehensive comparative analysis of the present disclosure (HeuRAL-MATE) is presented in comparison with baseline methods, specifically the brute-force optimal approach and the FIFO strategy. The fundamental logic for robot selection remains consistent across both the learning-based policy and the baseline strategies. The experiments encompass scenarios with and without charging considerations, effectively addressing real-world operational challenges. The results consistently highlight the superiority of HeuRAL-MATE over the baseline methods.

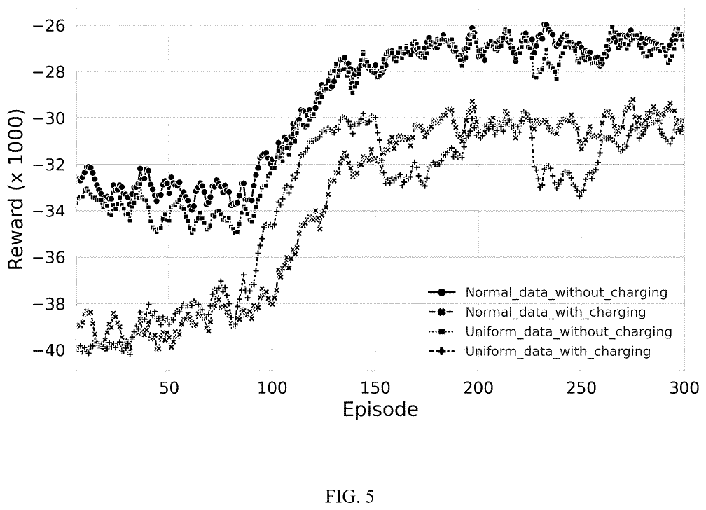

FIG. 5 is a graph illustrating an average training curve for the RL approach, in accordance with some embodiments of the present disclosure. The average is computed from four distinct runs utilizing random initial seeds. The RL model undergoes 300 training episodes, each encompassing 505 tasks with 10 robots in the environment and LA length 5. This training employs the PPO-based RL algorithm within the PFRL framework. The training procedure utilizes randomly generated task lists sampled from Gaussian distribution to mirror real-world task profiles, alongside uniformly sampled task lists. Separate models are trained for both robot charging and non-charging scenarios using both datasets. The reward plots illustrate the stable convergence of the HeuRAL-MATE towards a favorable optimal policy. Enhancements in rewards compared to initial values indicate proficient task selection and allocation to robots, leading to decreased waiting times for tasks within the LA. It is important to note that the RL agent was trained using a random task list periodically, preventing it from merely memorizing performance on a particular task list. Instead, it learns to adeptly adapt to various scenarios. This explains the minor fluctuations in rewards across episodes, even as the agent develops a steady policy.

Following the training phase, the model's performance is evaluated across various test datasets. For the model trained on task lists adhering to a specific Gaussian distribution, the assessment encompasses four distinct datasets: (a) instances analogous to the training data with the same mean and variance, (b) datasets displaying ±30% variations, termed moderate variation, and (c) testing on an entirely distinct uniformly generated dataset. This evaluation aims to measure HeuRAL-MATE's performance in handling distributional shifts. Meanwhile, the model trained on instances generated from a uniform distribution is evaluated using two separate test datasets: (a) dataset sampled from same distribution and (b) dataset generated using a Gaussian distribution, providing insights into its capabilities under distributional shift.

Table 1 presents a comprehensive comparison of the test results on various test datasets with 5 tasks in LA buffer, 10 robots and 505 tasks per episode (the lower the better). It is noteworthy that the total number of tasks in the entire episode, the number of deployed robots, and the length of the LA buffer remain consistent with the training phase, specifically 505 tasks, 10 robots, and an LA length of 5. The results underscore HeuRAL-MATE's consistent outperformance over brute-force optimal and FIFO-based methods across nearly all test scenarios. Only in a couple of instances does the brute-force approach marginally surpass HeuRAL-MATE. These cases involve uniformly distributed task arrival times throughout the episode, where the brute-force optimal approach, with bruteforce evaluations at any point, proves to be a potent heuristic. Additionally, Table 1 provides execution time details, further confirming the efficiency of HeuRAL-MATE in handling large order volumes within notably brief timeframes. This highlights HeuRAL-MATE's adaptability to dynamic variations in task management and its effective handling of substantial volumes of online orders, exhibiting a total cost improvement of 8.58% and 10.74% compared to the brute-force optimal approach and FIFO heuristics, respectively.

TABLE 1

| | | Charging | | | Non-Charging | | |
|---|---|---|---|---|---|---|---|
| | | | Brute- | | | Brute- | |
| | Test | HeuRAL- | force | | HeuRAL- | force | |
| | Distribution | MATE | optimal | FIFO | MATE | optimal | FIFO |
| Training | Similar | 28.81 ± 0.08 | 29.18 | 32.7 | 24.36 ± 0.29 | 27.01 | 27.6 |
| with | | 28.98 ± 0.24 | 30.91 | 31.4 | 25.83 ± 0.14 | 26.83 | 27.9 |
| Gaussian | | 28.61 ± 0.35 | 30.92 | 31.4 | 26.41 ± 0.22 | 28.38 | 28.8 |
| distribution | | 28.32 ± 0.25 | 29.21 | 31.7 | 24.80 ± 0.44 | 26.7 | 27.9 |
| data | | 28.62 ± 0.23 | 29.82 | 31.7 | 26.73 ± 0.59 | 28.03 | 28.5 |
| | Moderately | 28.44 ± 0.62 | 29.22 | 31.2 | 25.29 ± 0.09 | 27.29 | 27.4 |
| | different | 29.99 ± 0.82 | 31.2 | 31.7 | 25.81 ± 1.01 | 26.39 | 28.4 |
| | | 30.32 ± 0.57 | 31.37 | 32 | 26.79 ± 0.50 | 27.55 | 29.5 |
| | | 28.79 ± 0.48 | 31.11 | 31.6 | 24.79 ± 0.05 | 26.43 | 27 |
| | | 29.57 ± 0.18 | 32.4 | 33.7 | 26.50 ± 0.17 | 27.28 | 29.3 |
| | Totally | 29.01 ± 0.45 | 30.34 | 31.7 | 25.78 ± 0.20 | 27.79 | 27.8 |
| | different | 29.04 ± 0.46 | 30.87 | 32.8 | 26.65 ± 0.11 | 27.75 | 27.8 |
| | | 31.02 ± 2.02 | 31.72 | 33.6 | 27.31 ± 0.05 | 28.81 | 28.8 |
| | | 29.18 ± 0.93 | 31.48 | 33 | 25.84 ± 0.32 | 26.27 | 26.3 |
| | | 29.02 ± 2.04 | 28.95 | 33.3 | 27.57 ± 0.34 | 29.02 | 29 |
| Training | Similar | 29.90 ± 1.18 | 30.29 | 33.2 | 27.41 ± 0.07 | 28.81 | 29.9 |
| with | | 28.81 ± 0.76 | 31.55 | 31.8 | 25.62 ± 0.33 | 26.27 | 27.9 |
| uniform | | 29.70 ± 1.08 | 32.12 | 33.2 | 26.73 ± 0.03 | 29.02 | 29.2 |
| data | | 29.57 ± 0.83 | 31.34 | 33.2 | 26.53 ± 0.75 | 28.65 | 27.9 |
| | | 28.07 ± 0.91 | 30.4 | 32 | 26.53 ± 0.01 | 27.5 | 27.6 |
| | Different | 28.87 ± 0.14 | 27.96 | 31.8 | 25.11 ± 0.14 | 27.01 | 27.6 |
| | | 30.13 ± 0.85 | 30.7 | 31.6 | 25.98 ± 0.17 | 26.83 | 27.9 |
| | | 28.65 ± 0.15 | 31.68 | 32.1 | 24.84 ± 2.20 | 28.38 | 28.8 |
| | | 28.02 ± 0.28 | 30.91 | 31.4 | 25.46 ± 0.20 | 26.7 | 27.9 |
| | | 30.26 ± 0.79 | 31.39 | 33.2 | 26.50 ± 0.16 | 25.63 | 27.9 |
| | Avg run- | 0.17 | 0.88 | 0.15 | 0.14 | 0.79 | 0.13 |
| | time(s/task) | | | | | | |

To evaluate the generalizability of HeuRAL-MATE, experiments involving varying numbers of robots and tasks are conducted during inference. Initially, the model is trained for a fleet comprising 20 robots, Subsequently, the performance of the trained RL agent is assessed in scenarios where only 15 robots are available without having to retrain the model. This is readily achieved by artificially assigning extremely large values to the parameter t_{wait} for the additional 5 robots, effectively preventing any task allocation to these 5 robots. Table 2 shows the results on experiments conducted on Gaussian distributed dataset (charging) with 5 tasks in LA, 20 robots & 505 episodic tasks.

TABLE 2
Gaussian distribution data

| HeuRAL-MATE | Brute-force optimal | FIFO |
|---|---|---|
| 20.6 | 22.13 | 22.35 |
| 21.73 | 21.84 | 22.61 |
| 20.95 | 21.65 | 21.99 |
| 20.61 | 22.01 | 22.1 |
| 21.6 | 22.79 | 23.38 |

Table 3 shows the evaluation on Gaussian distributed dataset (charging) with 5 tasks in LA, 10 robots & 1005 episodic tasks. The HeuRAL-MATE agent of the present disclosure was trained for a fleet of 10 robots and 505 tasks on variable number of tasks—1005 tasks. It was observed that HeuRAL-MATE of the present disclosure consistently outperforms the baselines for variable number of tasks without requiring model retraining.

TABLE 3
Gaussian distribution data

| HeuRAL-MATE | Brute-force optimal | FIFO |
|---|---|---|
| 58.57 ± 0.37 | 62.15 | 65.89 |
| 56.47 ± 0.17 | 61.39 | 64.78 |
| 58.54 ± 0.32 | 60.41 | 66.49 |
| 57.69 ± 0.44 | 63.44 | 67.23 |
| 56.70 ± 0.10 | 60.17 | 63.64 |

Despite common intuition, brute-force optimal approach is one of the strongest baselines which, given the causal state of the environment, evaluates all possible task-robot pairs and optimally selects the suitable pair for subsequent execution. As such, this approach is computationally exhaustive and does not scale well with the number of robots or LA length. Moreover, the approach is greedily optimal, and it is difficult for most algorithms to outperform it. The reason why HeuRAL-MATE is able to outperform it is due to non-adherence of brute-force optimal in ensuring that tasks do not remain in the LA beyond a threshold which results in a penalty, and the fact that HeuRAL-MATE exploits the underlying distribution defining task generation to plan for tasks to appear in future despite it having access to the same causal information as brute-force optimal.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments of the present disclosure herein address unresolved problems of real-time multi-robot task allocation (MRTA) in various dynamic applications such as a warehouse setting, where tasks appear dynamically with corresponding start and end locations. The objective of the present disclosure is to minimize both the total travel distance of robots and the delay in task execution while considering practical charging/discharging constraints and collision-free navigation. To tackle this combinatorially hard problem, the heuristic guided reinforcement learning (RL) agent called HeuRAL-MATE, is trained which learns to prioritize prompt task execution while optimizing the assignment of tasks to robots.

style-based clustering of artworks with preference feedback, which discloses a preference feedback mechanism or loop with four operations: sample, expand, merge, and project. The sample operation facilitates the selection of samples for feedback. The preference feedback on the selected subset of the dataset is captured through the expand and merge operations. Finally, the preference feedback is projected onto the entire dataset through the project operation. The methods and systems of the present disclosure drive a generic clustering models to cluster artworks based on artistic style with the introduction of minimal preference feedback.

It is to be understood that the scope of the protection is extended to such a program and in addition to a computer-readable means having a message therein; such computer-readable storage means contain program-code means for implementation of one or more steps of the method, when the program runs on a server or mobile device or any suitable programmable device. The hardware device can be any kind of device which can be programmed including e.g., any kind of computer like a server or a personal computer, or the like, or any combination thereof. The device may also include means which could be e.g., hardware means like e.g., an application-specific integrated circuit (ASIC), a field-programmable gate array (FPGA), or a combination of hardware and software means, e.g., an ASIC and an FPGA, or at least one microprocessor and at least one memory with software processing components located therein. Thus, the means can include both hardware means, and software means. The method embodiments described herein could be implemented in hardware and software. The device may also include software means. Alternatively, the embodiments may be implemented on different hardware devices, e.g., using a plurality of CPUs.

The embodiments herein can comprise hardware and software elements. The embodiments that are implemented in software include but are not limited to, firmware, resident software, microcode, etc. The functions performed by various components described herein may be implemented in other components or combinations of other components. For the purposes of this description, a computer-usable or computer readable medium can be any apparatus that can comprise, store, communicate, propagate, or transport the program for use by or in connection with the instruction execution system, apparatus, or device.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope of disclosed embodiments being indicated by the following claims.

What is claimed is:

1. A processor-implemented method, comprising:
receiving, via one or more input/output (I/O) interfaces, a plurality of tasks to be performed by a plurality of robots in a dynamic environment, and wherein each task of the plurality of tasks comprises one or more task parameters and each robot of the plurality of robots are identified with one or more robot parameters, and wherein the one or more task parameters of each task comprises (i) a task origin, (ii) a task destination, (iii) a task length, (iv) a task appearing time in a task look-ahead (LA) buffer, and (v) a task generation time, and the one or more robot parameters of each robot comprises (i) a robot current position, (ii) a robot availability time, and (iii) a robot charging percentage; and
allocating, via one or more hardware processors, the plurality of tasks to the plurality of robots, through (i) a PPO based reinforcement learning model, and (ii) heuristics, based on the one or more task parameters of each task of the one or more tasks and the one or more robot parameters of each robot to obtain an optimized multi-robot task allocation, by:
(a) initializing one or more policy network parameters and one or more value network parameters of the PPO based reinforcement learning model, wherein the PPO based reinforcement learning model comprises a plurality of feature extraction layers, a concatenation layer, and a policy layer;
(b) moving one or more tasks out of the plurality of tasks that are unallocated, to the task look-ahead buffer, based on the task generation time of each task and a size of the task look-ahead buffer;
(c) passing the one or more task parameters of each task of the one or more tasks to the plurality of feature extraction layers, to obtain a task-specific feature vector of each task of the one or more tasks;
(d) passing the one or more robot parameters of each robot of the plurality of robots to the plurality of feature extraction layers, to obtain a robot-specific feature vector of each robot of the plurality of robots;
(e) summation of (i) the task-specific feature vector of each task of the one or more tasks and (ii) the robot-specific feature vector of each robot of the plurality of robots, to obtain an integrated task-robot feature vector;
(f) concatenating the integrated task-robot feature vector with an intermediate task-specific feature vector of each task of the one or more tasks using the concatenation layer, to obtain a concatenated task-robot feature vector, wherein the intermediate task-specific feature vector of each task is a part of the task-specific feature vector associated to each task;
(g) passing the concatenated task-robot feature vector to the policy layer to allocate each task of the one or more tasks, at each time-step, to a robot of the plurality of robots, using the heuristics;
(h) calculating a value of a reward function for training the PPO based reinforcement learning model, based on allocation of each task of the one or more tasks to the robot of the plurality of robots;
(i) employing a navigation path algorithm for navigating the robot to complete each task allocated to each robot;
(j) repeating the steps (c) through (i) until the one or more tasks present in the task look-ahead buffer is completed;
(k) repeating the steps (b) through (j) until the plurality of tasks is completed;
(l) calculating a value of a policy loss function and a value of a value loss function using the one or more policy network parameters and the one or more value network parameters, respectively;
(m) updating the one or more policy network parameters and the one or more value network parameters of the PPO based reinforcement learning model, based on the value of the policy loss function and the value of the value loss function respectively to obtain one or more updated policy network parameters and one or more updated value network parameters; and
(n) repeating the steps (a) through (m), until a plurality of episodes is completed by considering the one or more updated policy network parameters as the one or more updated policy network parameters and the one or more updated value network parameters as the one or more value network parameters.

2. The processor-implemented method of claim 1, wherein the heuristics employ one of: (i) a greedy best-first search algorithm, (ii) a minimum completion time (MCT) search algorithm, and (iii) a brute-force search algorithm, to select the robot out of the plurality of robots for assigning each task at time of the one or more tasks, based on the robot charging percentage.

3. The processor-implemented method of claim 1, wherein the reward function for training the PPO based reinforcement learning model is defined based on (i) a distance between the robot current position of each robot allocated to the task and the task origin associated to the task allocated with the robot, (ii) a difference between a time step at which the task is allocated with the robot and the task appearing time of the task in the task look-ahead buffer, and (iii) a penalty for each task of the one or more tasks present in the task look-ahead buffer being unallocated for more than a predefined threshold time.

4. The processor-implemented method of claim 1, wherein the navigation path algorithm determines a collision-free path planning for the robot allocated with each task to navigate through the robot current location, the task origin and the task destination, for completion of each task allocated to each robot.

5. The processor-implemented method of claim 4, wherein each task allocated and completed by the robot is removed from the task look-ahead buffer.

6. A system, comprising:
a memory storing instructions;
one or more input/output (I/O) interfaces;
one or more hardware processors coupled to the memory via the one or more I/O interfaces, wherein the one or more hardware processors are configured by the instructions to:
receive, via the one or more I/O interfaces, a plurality of tasks to be performed by a plurality of robots in a dynamic environment, and wherein each task of the plurality of tasks comprises one or more task parameters and each robot of the plurality of robots are identified with one or more robot parameters, and wherein the one or more task parameters of each task comprises (i) a task origin, (ii) a task destination, (iii) a task length, (iv) a task appearing time in a task look-ahead (LA) buffer, and (v) a task generation time, and the one or more robot parameters of each robot comprises (i) a robot current position, (ii) a robot availability time, and (iii) a robot charging percentage; and
allocate the plurality of tasks to the plurality of robots, through (i) a PPO based reinforcement learning model, and (ii) heuristics, based on the one or more task parameters of each task of the one or more tasks and the one or more robot parameters of each robot to obtain an optimized multi-robot task allocation, by:
(a) initializing one or more policy network parameters and one or more value network parameters of the PPO based reinforcement learning model, wherein the PPO based reinforcement learning model comprises a plurality of feature extraction layers, a concatenation layer, and a policy layer;
(b) moving one or more tasks out of the plurality of tasks that are unallocated, to the task look-ahead buffer, based on the task generation time of each task and a size of the task look-ahead buffer;
(c) passing the one or more task parameters of each task of the one or more tasks to the plurality of feature extraction layers, to obtain a task-specific feature vector of each task of the one or more tasks;
(d) passing the one or more robot parameters of each robot of the plurality of robots to the plurality of feature extraction layers, to obtain a robot-specific feature vector of each robot of the plurality of robots;
(e) summation of (i) the task-specific feature vector of each task of the one or more tasks and (ii) the robot-specific feature vector of each robot of the plurality of robots, to obtain an integrated task-robot feature vector;
(f) concatenating the integrated task-robot feature vector with an intermediate task-specific feature vector of each task of the one or more tasks using the concatenation layer, to obtain a concatenated task-robot feature vector, wherein the intermediate task-specific feature vector of each task is a part of the task-specific feature vector associated to each task;
(g) passing the concatenated task-robot feature vector to the policy layer to allocate each task of the one or more tasks, at each time-step, to a robot of the plurality of robots, using the heuristics;
(h) calculating a value of a reward function for training the PPO based reinforcement learning model, based on allocation of each task of the one or more tasks to the robot of the plurality of robots;
(i) employing a navigation path algorithm for navigating the robot to complete each task allocated to each robot;
(j) repeating the steps (c) through (i) until the one or more tasks present in the task look-ahead buffer is completed;
(k) repeating the steps (b) through (j) until the plurality of tasks is completed;
(l) calculating a value of a policy loss function and a value of a value loss function using the one or more policy network parameters and the one or more value network parameters, respectively;
(m) updating the one or more policy network parameters and the one or more value network parameters of the PPO based reinforcement learning model, based on the value of the policy loss function and the value of the value loss function respectively to obtain one or more updated policy network parameters and one or more updated value network parameters; and
(n) repeating the steps (a) through (m), until a plurality of episodes is completed by considering the one or more updated policy network parameters as the one or more updated policy network parameters and the one or more updated value network parameters as the one or more value network parameters.

7. The system of claim 6, wherein the heuristics employ one of: (i) a greedy best-first search algorithm, (ii) a minimum completion time (MCT) search algorithm, and (iii) a brute-force search algorithm, to select the robot out of the plurality of robots for assigning each task at time of the one or more tasks, based on the robot charging percentage.

8. The system of claim 6, wherein the reward function for training the PPO based reinforcement learning model is defined based on (i) a distance between the robot current position of each robot allocated to the task and the task origin associated to the task allocated with the robot, (ii) a difference between a time step at which the task is allocated with the robot and the task appearing time of the task in the task look-ahead buffer, and (iii) a penalty for each task of the one or more tasks present in the task look-ahead buffer being unallocated for more than a predefined threshold time.

9. The system of claim 6, wherein the navigation path algorithm determines a collision-free path planning for the robot allocated with each task to navigate through the robot current location, the task origin and the task destination, for completion of each task allocated to each robot.

10. The system of claim 9, wherein each task allocated and completed by the robot is removed from the task look-ahead buffer.

11. One or more non-transitory machine-readable information storage mediums comprising one or more instructions which when executed by one or more hardware processors cause:
receiving a plurality of tasks to be performed by a plurality of robots in a dynamic environment, and wherein each task of the plurality of tasks comprises one or more task parameters and each robot of the plurality of robots are identified with one or more robot parameters, and wherein the one or more task parameters of each task comprises (i) a task origin, (ii) a task destination, (iii) a task length, (iv) a task appearing time in a task look-ahead (LA) buffer, and (v) a task generation time, and the one or more robot parameters of each robot comprises (i) a robot current position, (ii) a robot availability time, and (iii) a robot charging percentage; and
allocating the plurality of tasks to the plurality of robots, through (i) a PPO based reinforcement learning model, and (ii) heuristics, based on the one or more task parameters of each task of the one or more tasks and the one or more robot parameters of each robot to obtain an optimized multi-robot task allocation, by:
(a) initializing one or more policy network parameters and one or more value network parameters of the PPO based reinforcement learning model, wherein the PPO based reinforcement learning model comprises a plurality of feature extraction layers, a concatenation layer, and a policy layer;
(b) moving one or more tasks out of the plurality of tasks that are unallocated, to the task look-ahead buffer, based on the task generation time of each task and a size of the task look-ahead buffer;
(c) passing the one or more task parameters of each task of the one or more tasks to the plurality of feature extraction layers, to obtain a task-specific feature vector of each task of the one or more tasks;
(d) passing the one or more robot parameters of each robot of the plurality of robots to the plurality of feature extraction layers, to obtain a robot-specific feature vector of each robot of the plurality of robots;
(e) summation of (i) the task-specific feature vector of each task of the one or more tasks and (ii) the robot-specific feature vector of each robot of the plurality of robots, to obtain an integrated task-robot feature vector;
(f) concatenating the integrated task-robot feature vector with an intermediate task-specific feature vector of each task of the one or more tasks using the concatenation layer, to obtain a concatenated task-robot feature vector, wherein the intermediate task-specific feature vector of each task is a part of the task-specific feature vector associated to each task;
(g) passing the concatenated task-robot feature vector to the policy layer to allocate each task of the one or more tasks, at each time-step, to a robot of the plurality of robots, using the heuristics;
(h) calculating a value of a reward function for training the PPO based reinforcement learning model, based on allocation of each task of the one or more tasks to the robot of the plurality of robots;
(i) employing a navigation path algorithm for navigating the robot to complete each task allocated to each robot;
(j) repeating the steps (c) through (i) until the one or more tasks present in the task look-ahead buffer is completed;
(k) repeating the steps (b) through (j) until the plurality of tasks is completed;
(l) calculating a value of a policy loss function and a value of a value loss function using the one or more policy network parameters and the one or more value network parameters, respectively;
(m) updating the one or more policy network parameters and the one or more value network parameters of the PPO based reinforcement learning model, based on the value of the policy loss function and the value of the value loss function respectively to obtain one or more updated policy network parameters and one or more updated value network parameters; and
(n) repeating the steps (a) through (m), until a plurality of episodes is completed by considering the one or more updated policy network parameters as the one or more updated policy network parameters and the one or more updated value network parameters as the one or more value network parameters.

12. The one or more non-transitory machine-readable information storage mediums of claim 11, wherein the heuristics employ one of: (i) a greedy best-first search algorithm, (ii) a minimum completion time (MCT) search algorithm, and (iii) a brute-force search algorithm, to select the robot out of the plurality of robots for assigning each task at time of the one or more tasks, based on the robot charging percentage.

13. The one or more non-transitory machine-readable information storage mediums of claim 11, wherein the reward function for training the PPO based reinforcement learning model is defined based on (i) a distance between the robot current position of each robot allocated to the task and the task origin associated to the task allocated with the robot, (ii) a difference between a time step at which the task is allocated with the robot and the task appearing time of the task in the task look-ahead buffer, and (iii) a penalty for each task of the one or more tasks present in the task look-ahead buffer being unallocated for more than a predefined threshold time.

14. The one or more non-transitory machine-readable information storage mediums of claim 11, wherein the navigation path algorithm determines a collision-free path planning for the robot allocated with each task to navigate through the robot current location, the task origin and the task destination, for completion of each task allocated to each robot.

15. The one or more non-transitory machine-readable information storage mediums of claim 14, wherein each task allocated and completed by the robot is removed from the task look-ahead buffer.
